(19) United States
(12) Patent Application Publication
(10) Pub. No.: US 2009/0274923 A1
(43) Pub. Date: Nov. 5, 2009

(54) Tools Having Compacted Powder Metal Work Surfaces, And Method

(76) Inventors: Kenneth Hall, East Longmeadow, MA (US); Glenn L. Beane, Hanover, NH (US)

Correspondence Address: MCCARTER & ENGLISH, LLP HARTFORD;CITYPLACE I, 185 ASYLUM STREET, HARTFORD, CT, 06103, US

(21) Appl. No.: 12/397,282

(22) Filed: Mar. 3, 2009

Related U.S. Application Data
(60) Provisional application No. 61/033,704, filed on Mar. 4, 2008.

(51) Int. Cl. B32B 15/02; B22F 7/04; B22F 3/12

(52) U.S. Cl. 428/564; 419/8; 425/78; 428/553

(57) ABSTRACT

A method and apparatus for forming a net or near net shaped work surface includes providing a substrate and engaging a die with the substrate forming a die cavity enclosing a portion of the substrate. A powdered metal is introduced into the cavity, heated prior to and within the die cavity, and pressurized to consolidate the powdered metal. The die is then disengaged from the substrate. In one exemplary embodiment, the work surface forms the cutting teeth of a saw blade.

### CROSS REFERENCE TO PRIORITY APPLICATION

This patent application claims priority on U.S. provisional patent application Ser. No. 61/033,704, filed Mar. 4, 2008, entitled “Tools Having Compacted Powder Metal Work Surfaces, And Method”, which is hereby expressly incorporated by reference in its entirety as part of the present disclosure.

### FIELD OF THE INVENTION

The present invention relates to tools having compacted powdered metal work surfaces, and more particularly, to tools, such as cutting tools, including band saw blades, having compacted powdered metal cutting or other work surfaces formed in finished or near finished shapes. The present invention also relates to methods of making tools having compacted powdered metal work surfaces, such as band saw blades, by depositing on tool substrates powdered metals defining finished or near finished shapes of work surfaces, such as the cutting teeth of band saw blades.

### BACKGROUND INFORMATION

A typical bi-metal band saw blade includes a spring steel backing that is electron beam welded to a high speed steel (“HSS”) or tool steel wire. The HSS wire is then machined to form the tips of the cutting teeth of the saw blade. For many years, conventional bi-metal band saw blades have employed as the backing steel an alloy designated as “D6A”. D6A is an ultra high strength steel adapted to be used in the 260-290 ksi tensile strength range by hardening, or austenitizing, at 1550° F. and tempering at 400° F. One of the drawbacks of this alloy, however, is that it has not been effective at temperatures required for heat treating HSS cutting teeth (e.g., about 2000°-2250° F. and tempering at about 800°-1100° F.).

One problem associated with heat treating bimetallic blades comes about after the HSS alloy is welded, typically by an electron beam welder, along an edge of the backing band. Inasmuch as the HSS alloy of the cutting edge and the backing steel are welded together along the length of the blade, it can be difficult to obtain the necessary properties of the HSS cutting edge, on the one hand, without bringing about a reduction of the flexibility, toughness and fatigue strength of the backing steel, on the other hand. In recent years, while cutting hard-to-cut materials over protracted periods of time using bimetallic blades, and when it has become necessary to replace such blades upon failure, inspection of such blades has shown that in many cases the failures occur in the backing band and not the HSS cutting edge.

Among the more recent prior art are U.S. Pat. No. 5,032,356 issued in 1991 to Kumagai and U.S. Pat. No. 5,091,264 issued in 1992 to Daxelmueller, which have directed their focus on alloys for use as the backing steel welded to high speed steel cutting edge materials in fabricating bimetallic band saw blades. The patent to Daxelmueller focuses on martensitically hardenable maraging steel containing, in relatively large quantities ranging from a minimum of 10% to a maximum of 55% by weight total of the alloy elements, Ni, Co and Mo, which can be considered relatively rare and expensive materials. The Daxelmueller patent discloses and claims that support strips 1 have at least 10% by weight of alloying components. In Table 1 (Column 4) and Table 3 (Column 50) of Daxelmueller the constituents of a tool steel and backing band or support strip are generally the same materials that are used in both the cutting and backing portions of such blades. The Daxelmueller patent also discusses bimetallic band saw blades wherein a HSS edge is electron beam welded to the backing strip. Usually, the welding step is followed by tempering of the longitudinal section or zone hardened by the welding and annealing steps. After the teeth are cut and set, the blade is hardened by heating to a temperature of 1120° C., which is maintained for fifty-five (55) seconds, and then the blade is quenched in oil. The blade is then tempered by heating to 560° C. and cooling in air for 1.2 hours, and by heating again to 560° C. and then cooling in air for one hour. Blades of this construction have been demonstrated to provide 71,000 load cycles prior to failure, but include large amounts of the following three, relatively rare and expensive alloy elements: Mo—4.3%; Ni—18.1%, and Co—12.07% by weight.

It would be desirable to produce the work surfaces of tools, such as the cutting teeth of saw blades, to finished or near finished shapes, thereby minimizing the amount of grinding and/or machining necessary to achieve the required dimensions of the finished work surfaces. Present techniques include the manufacture of carbide-tipped saw blades, which are formed by welding or brazing carbide cylinders onto the upper, leading edge portion of each tooth of the saw blade. The carbide cylinders are formed of powdered raw materials, such as tungsten carbide (WC), cobalt (Co), graphite, polymer binder, solvent, and other additives, such as tungsten (W) and grain growth inhibitors. The powdered raw materials are ball milled to homogenize and reduce the grain size of the WC and Co particles. The powdered raw materials are then spray dryed to remove solvent and form and control the size of the powder granules. The powder granules are then filled into die cavities, pressed to about 75% density, and then ejected. The density of the compact is controlled to limit cracking at ejection. The pressed cylinders are then sintered including an initial de-waxing process that takes place between about 0-400° C. for about 200 minutes, a solid state sinter that occurs below the eutectic temperature (≦about 1400° C.) for about 200 minutes, and a liquid phase sinter that occurs above the eutectic temperature (about +/−1,400° C. to about +/−1,500° C.) for about 200 minutes. The sintered cylinders are then finished to control size and tolerance. The finished cylinders are then nickel (Ni) plated to improve ductility at the interface when welded to the steel backing. The Ni-plated cylinders are then welded to the steel tooth forms on the blade. The time, temperature and pressure are controlled to properly weld the cylinders to the steel tooth forms. After welding, the gross cylinder shapes are ground and sharpened to form the net or finished tooth tip shapes.

One of the drawbacks of such prior art carbide-tipped saw blades, and methods of making such blades, is that the manufacturing process is relatively complex and costly. Another drawback is that because the cylinders are welded to the steel tooth forms or backing, the types of materials and/or their shapes are limited to those that can be successfully welded. Yet another drawback is that the carbide cylinders must be ground and sharpened to form the finished or net tip shapes. This processing not only adds expense, but limits the tooth tip shapes and materials to those that can be ground or otherwise formed with existing machining processes.

Other products and parts are formed by powder metallurgy, such as by pressing finely ground or atomized metal powders into a desired shape within a die cavity of a powder press. Generally, the metal powders are compacted in the die cavity at room temperature and then the semi-dense “green” compact is removed from the die and sintered at very high temperatures (at or near the melting point of the material) to bond the powders into a unified mass.

It can be difficult to manufacture complex tool tip shapes with tight dimensional tolerances using prior art powder metallurgy techniques. For example, the required high temperature sintering step (to increase the density of the part) may distort the part from its original shape and thus make it commercially useless. Likewise, in order for a band saw blade backing, for example, to remain flexible and tough, care must be taken not to change the material properties of the backing when heating thereof (e.g., when brazing or welding shaped pieces of carbide to the backing), because excessive heat applied to the backing and/or the interface between the carbide tip and backing could produce a brittle band saw blade. Such complex parts are therefore typically individually machined using relatively expensive techniques.

Accordingly, it is an object of the present invention to overcome one or more of the above-described drawbacks and/or disadvantages of the prior art.

### SUMMARY OF THE INVENTION

In accordance with a first aspect, the present invention is directed to a method of forming a tool having a compacted powder work surface. The method comprises the following steps:

(i) providing a tool substrate;

(ii) moving at least one die surface into engagement with the substrate and forming a die cavity substantially enclosing at least a portion of the substrate;

(iii) introducing powder metal into the die cavity;

(iv) heating the powder metal;

(v) compacting the powder metal and forming a near net shape or net shape compacted powder work surface within the die cavity and bonded to the substrate; and

(vi) disengaging the at least one die surface from the substrate and forming a compacted near net shape or net shape compacted powder work surface on the substrate

In one embodiment of the present invention, the compacting step includes applying pressure to the compacted powder metal within the die cavity, and further comprising heating at least an interface between the substrate and the compacted powder metal while applying pressure to the compacted powder metal within the die cavity. In one embodiment of the present invention, the compacting step includes moving at least one of the at least one die surface and the substrate toward the other to press at least one of the substrate and powder metal into engagement with the other and, in turn, press the compacted powder metal within the die cavity. In some such embodiments, the compacting step further includes driving the substrate at least partially into the die cavity and, in turn, pressing the compacted powder metal within the die cavity. In one such embodiment, the at least one die surface deformably engages the substrate. Preferably, the at least one die surface engaging the substrate forms a substantially hermetic seal between the die cavity and substrate.

Some embodiments of the present invention further comprise heating the powder metal prior to introducing the powder metal into the die cavity. In some such embodiments, the powder metal is heated up to about 50% to about 75% of its sintering or melting temperature prior to or at the time of introducing the powder metal into the die cavity. In other embodiments, the powder metal is heated up to about 50% of its melting temperature to about its melting temperature prior to or at the time of introducing the powder metal into the die cavity. Some such embodiments employ a heated fluidized bed to fluidize and preheat the powder metal prior to and/or at the time of introducing the powder metal into the die cavity. One such embodiment uses an external energy or heat source, such as a plasma heat source, with heated gas, such as argon gas, to heat and fluidize the heated powder metal for transport into the die cavity. In one such embodiment, the plasma heat source creates a heated column of argon gas that fluidizes and preheats the powder metal prior to or at the time of introducing the powder metal into the die cavity. In one such embodiment, the preheat temperature is close to, but below, the sintering or melting temperature of the powder metal (e.g., up to about 50% to about 75% of its sintering or melting temperature). In another embodiment, the preheat temperature is up to about 50% of the melting temperature to about the melting temperature of the powder metal. The powder metal is then further heated in the die cavity.

Some embodiments of the present invention further comprise the step of forming an upset at an interface of the substrate and powder metal and, in turn, forming a mechanical interlock between the substrate and powder metal. In some such embodiments, the upset is defined by a protuberance and/or a recess formed on the substrate at an interface between the substrate and powder metal. In one such embodiment, the protuberance and/or recess is substantially dove-tail shaped.

In some embodiments of the present invention, the heating step includes (i) preheating the powder metal prior to introduction into the die cavity; (ii) preheating and fluidizing the powder metal prior to introduction into the die cavity; (iii) heating at least one die surface and, in turn, heating the compacted powder metal within the die cavity; and/or (iv) disengaging the at least one die surface from the compacted powder metal and heating the compacted powder metal.

In some embodiments of the present invention, the compacting step further includes providing at least one movable die surface, driving the at least one movable die surface into engagement with the powder metal within the die cavity, and pressing the powder metal within the die cavity.

Some embodiments of the present invention further comprise providing the substrate in the form of a saw blade, and forming the compacted powder work surface into a net or near net shaped cutting tip of the saw blade. Some such embodiments further comprise providing the powder metal including a plurality of WC particles coated with at least one of Co and Ni.

In accordance with another aspect, the present invention is directed to an apparatus for forming a tool having a compacted powder work surface. The apparatus comprises at least one die surface movable into engagement with a substrate of the tool and forming a die cavity substantially enclosing at least a portion of the substrate. The apparatus includes first means for introducing powder metal into the die cavity; second means for heating the powder metal to its sintering or melting temperature; third means for compacting the powder metal within the die cavity and into engagement with the substrate, and for forming a near net shape or net shape compacted powder work surface within the die cavity and bonded to the substrate; and fourth means for disengaging the at least one die surface from the substrate and forming a compacted near net shape or net shape compacted powder work surface on the substrate.

In some embodiments of the present invention, the first means is a powder metal feed unit; the second means is a laser source, a RF source, a microwave source, a plasma source, an induction heater, an e-beam source, and/or a plasma/argon gas source; the third means is (i) at least one surface forming at least a portion of the die cavity movable into engagement with the powder metal within the die cavity, and/or (ii) a drive unit for driving at least one of the substrate and die cavity toward the other; and the fourth means is a drive unit for moving at least one die surface and, in turn, disengaging the at least one die surface from the near net shape or net shaped powder metal work surface.

In accordance with another aspect, the present invention is directed to apparatus for forming a tool having a compacted powder work surface. The apparatus comprises at least one die surface movable into engagement with a substrate of the tool and forming a die cavity substantially enclosing at least a portion of the substrate. A powder metal feed unit is in communication with the die cavity for introducing powder metal into the die cavity. An energy source preheats the powder metal prior to introduction into the die cavity, and/or heats the powder metal in the die cavity. The apparatus further comprises (i) at least one surface forming at least a portion of the die cavity movable into engagement with the powder metal within the die cavity for compacting the powder metal within the die cavity into engagement with the substrate, and/or (ii) a drive unit for driving at least one of the substrate and die cavity toward the other for compacting the powder metal within the die cavity into engagement with the substrate, for forming a near net shape or net shape compacted powder work surface within the die cavity and bonded to the substrate. A drive unit of the apparatus moves at least one die surface to disengage the at least one die surface from the near net shape or net shaped powder metal work surface from the substrate and form a compacted near net shape or net shaped compacted powder work surface on the substrate.

In some embodiments of the present invention, the thermal energy source is a laser source, a RF source, a microwave source, a plasma source, an induction heater, an e-beam source and/or a plasma/gas source.

Some embodiments further comprise a heated fluidized bed that fluidizes and preheats the powder metal prior to introducing and/or at the time of introducing the powder metal into the die cavity. In some such embodiments, the heated fluidized bed preheats the powder metal up to about 50% to about 75% of its sintering or melting temperature. In other embodiments, the heated fluidized bed preheats the powder metal up to about 50% to about the melting temperature of the powder metal. One such embodiment comprises an external energy or heat source, such as a plasma heat source, with heated gas, such as argon gas, to heat and fluidize the heated powder metal prior to and/or at the time of introduction into the die cavity. In one such embodiment, the plasma heat source creates a heated column of argon gas that fluidizes and heats the powder metal to a temperature close to, but below, its sintering or melting temperature (e.g., up to about 50% to about 75% of its sintering or melting temperature). In another embodiment, the plasma heat source creates a heated column of argon gas that fluidizes and heats the powder metal to a temperature up to about 50% of its melting temperature to about its melting temperature. The same or different heat source then further heats the powder metal in the die cavity.

In accordance with another aspect, the present invention is directed to a tool having a compacted powder metal work surface. The tool is formed in accordance with a method comprising the following steps:

(i) providing a tool substrate;

(ii) moving at least one die surface into engagement with the substrate and forming a die cavity substantially enclosing at least a portion of the substrate;

(iii) introducing powder metal into the die cavity;

(iv) at least one of preheating the powder metal prior to introducing the powder metal into the die cavity, and heating the powder metal in the die cavity;

(v) compacting the powder metal within the die cavity and into engagement with the substrate and forming a near net shape or net shape compacted powder work surface within the die cavity and bonded to the substrate; and

(vi) disengaging the at least two die surfaces from the substrate and forming a compacted near net shape or net shape compacted powder work surface on the substrate.

In accordance with another aspect, the present invention is directed to a tool having a compacted powder metal work surface. The tool comprises a substrate; and a compacted powder metal work surface defining a near net or net shape, wherein the powder metal includes a plurality of engineered coated particles including at least one first material coated with at least one second material. The second material portions of the particles are metallurgically bonded to each other and form a dense, compacted powder metal work surface.

Some embodiments of the present invention further define an upset at an interface of the substrate and powder metal forming a mechanical interlock between the substrate and powder metal. In some such embodiments, the upset is defined by a protuberance and/or a recess formed on the substrate at an interface between the substrate and powder metal. In some such embodiments, the protuberance and/or recess is substantially dove-tail shaped.

In some embodiments of the present invention, the work surface forms the cutting teeth of a saw blade, the work surface of a jaw of an adjustable wrench, or the head of a screw driver. In some such embodiments, the first material is tungsten carbide and the second material is cobalt and/or nickel. In one such embodiment, the tool is a saw blade and the work surface defines the tip of at least one cutting tooth of the saw blade.

One advantage of the present invention is that a tool may be provided with a compacted powder metal surface in a net or near net shape. As a result, many of the complicated and/or relatively expensive processes involved in manufacturing prior art tools, such as machining and grinding, can be avoided. Yet another advantage is that the work surfaces can be provided in shapes that were not achievable or commercially feasible when employing prior art conventional manufacturing processes. Still another advantage of the present invention is that it allows the use of materials, such as engineered alloys, not previously available or commercially feasible in the manufacture of certain types of tools, such as saw blades, thus allowing for enhanced performance and/or reduced expense in comparison to the prior art. A further advantage of some currently preferred embodiments of the present invention is that fully dense parts can be made from powdered metal materials using less expensive powder metallurgy techniques and, in some cases, fully dense parts can be made without using relatively high temperature sintering, thereby avoiding distorting the shape of the resulting part as encountered in the prior art.

Other objects and advantages of the present invention, and/or of the currently preferred embodiments, will become more readily apparent in view of the following detailed description of the currently preferred embodiments and accompanying drawings.

### BRIEF DESCRIPTION OF THE DRAWINGS

FIG. 1A is a side elevational view of a portion of a band saw blade;

FIG. 1B is a somewhat schematic illustration of an apparatus for manufacturing tools having compacted powder metal work surfaces, and illustrating the procedural steps for making such tools, in accordance with some embodiments of the present invention.

FIG. 2 is a perspective view of a saw blade backing material engaged with an exemplary apparatus for depositing powdered metal on each tip of the saw blade;

FIG. 3 is an enlarged perspective view of the apparatus of FIG. 2 illustrating translatable opposing dies separated from one another and translatable compaction pins engaged with a tip of the saw blade;

FIG. 4 is an enlarged perspective view of the apparatus of FIG. 3 illustrating one half of a die cavity formed when one of the dies is engaged with a tip of the saw blade;

FIG. 5 is a perspective cross-sectional view of the apparatus of FIG. 2 engaged with one tip of the saw blade and illustrating a die cavity defined by joining dies and a corresponding translatable compaction pin in each die;

FIG. 6 is a perspective view illustrating one compaction pin profile for defining a net or near net shaped tip of the saw blade;

FIG. 7 is a somewhat schematic, cross-sectional view of a tooth form made possible using a compaction pin as illustrated in FIG. 6 and having a corresponding profile;

FIG. 8 is a somewhat schematic, cross-sectional view of another tooth form made possible using a compaction pin as illustrated in FIG. 6 and having a corresponding profile;

FIG. 9 is a cross-sectional view of a coated particle utilized in making a compacted powder metal work surface; and

FIG. 10 is a perspective view of the apparatus of FIG. 4 further including a receptacle intermediate the pair of dies to pressurize the die cavity in accordance with an alternative embodiment.

### DETAILED DESCRIPTION OF THE CURRENTLY PREFERRED EMBODIMENTS

The present disclosure provides an apparatus and method capable of forming a finished or near finished work surface of a tool. In exemplary embodiments, the following description discloses an apparatus and method capable of forming a finished or near finished work surface of a tool by depositing a powdered material on a substrate. In some currently preferred embodiments, the powdered material is applied to a band saw blade backing to form finished or near finished shape cutting teeth on the saw blade. The powdered material used to form the work surfaces of the tools of the present invention can be any of numerous different materials or combinations of materials useful for such purposes that are currently known, or that later become known, such as powdered metals of high speed steel (“HSS”), carbide, cermet, and/or engineered alloys.

The terms “finished” or “net shape” are used synonymously in this disclosure to describe a product that could be used directly for its intended purpose. The term “near finished” or “near net shape” are used synonymously in this disclosure to describe a product that requires one or very few minimal operation(s), such as an edge qualifying top grind, after depositing the powdered metal, to obtain a finished or net shape part. The currently preferred embodiments of the present invention preferably provide finished or near finished tools having compacted powder metal work surfaces in finished or near finished shapes. In some embodiments of the present invention, the tools are saw blades, and the compacted powder metal work surfaces are the cutting teeth of the saw blades. In one such embodiment, the compacted powder metal cutting teeth are formed of carbide, and the carbide tipped cutting teeth have a fully sintered finished geometry. In other embodiments, the sintered geometry of the cutting teeth is such that not more than about one surface need be ground as a post sintering operation in order to complete the tooth form.

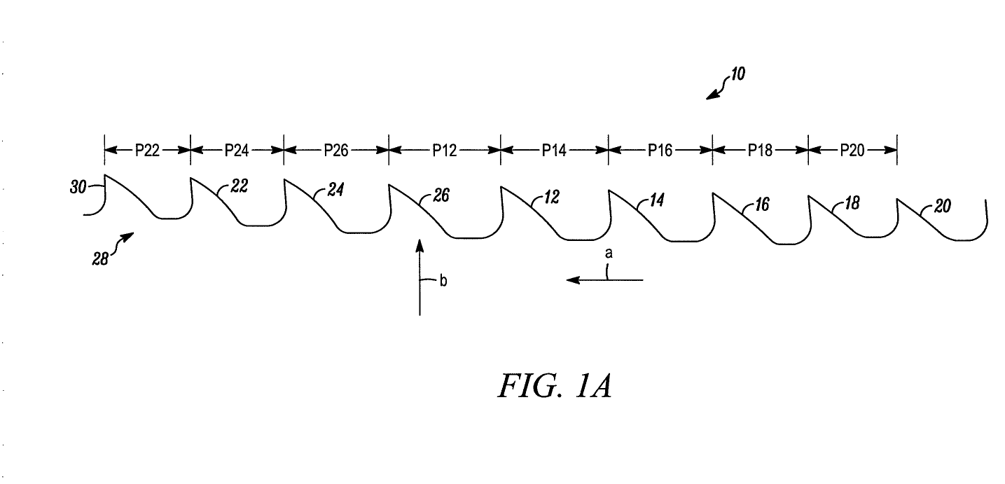

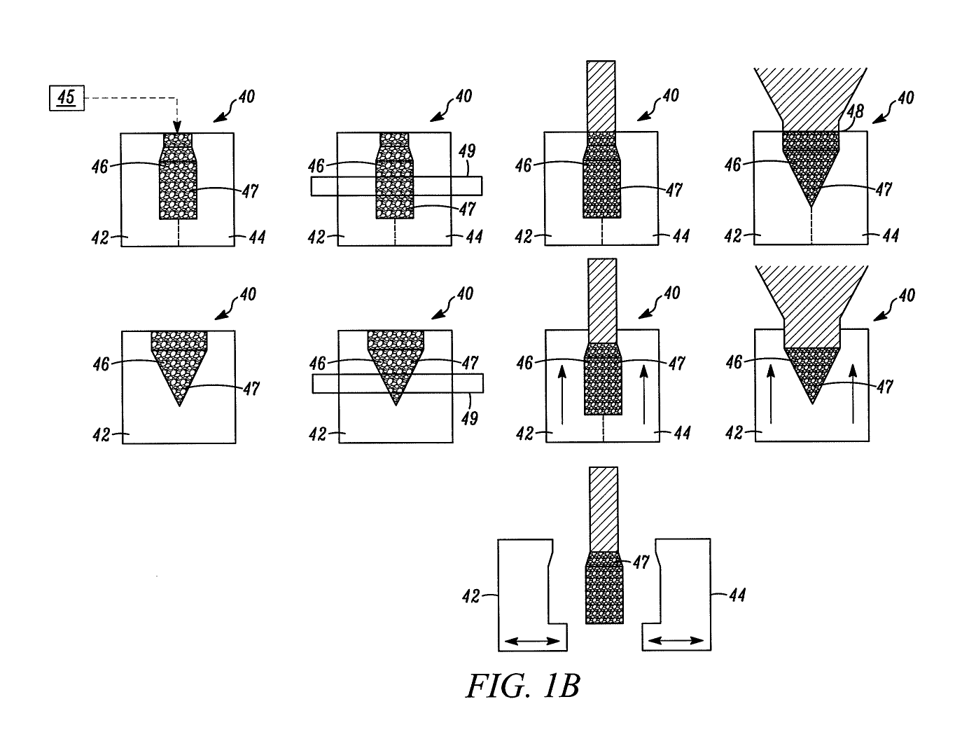

As shown typically in FIG. 1A, a band saw blade 10 defines a cutting direction indicated by the arrow “a”, and a feed direction indicated by the arrow “b”. The band saw blade 10 comprises a plurality of recurrent or repetitive patterns of teeth. In the illustrated embodiment, the band saw blade 10 defines an eight tooth pitch pattern; however, as may be recognized by those of ordinary skill in the pertinent art based on the teachings herein, this pitch pattern is only exemplary, and the saw blades of the present invention may define any of numerous different repetitive patterns of teeth. In the illustrated embodiment, each pitch pattern is defined by a recurrent group of eight successive teeth indicated by the reference numerals 12, 14, 16, 18, 20, 22, 24 and 26. As shown in FIG. 1A, each tooth defines a respective pitch or tooth spacing P12 through P26. As indicated in FIG. 1A, the pitch or tooth spacing may be measured between the tips of adjacent teeth. However, as may be recognized by those of ordinary skill in the pertinent art based on the teachings herein, the pitch or tooth spacing may be measured between any of numerous other corresponding points between adjacent teeth.

The saw blades of the present invention may define any of numerous different tooth forms or geometries that are currently known or that later become known. For example, the saw blades of the present invention may incorporate any of the features disclosed in the following commonly-assigned United States patents and patent application, each of which is hereby expressly incorporated by reference in its entirety as part of the present disclosure: U.S. Pat. Nos. 4,423,653, 5,417,777, 5,410,935, 6,003,422, 6,167,792, 6,276,248, 6,601,495, and 7,131,365. Indeed, one of the advantages of the present invention, is that it facilitates the ability to make the cutting teeth of saw blades or other tools out of any of numerous different materials, and in any of numerous different forms or geometries.

The saw blade 10 comprises a steel backing band 28 and a compacted powder metal cutting edge 30 defined by the repetitive patterns of cutting teeth 12-26. As described further below, the tips of the cutting teeth 12-26 may define any of numerous different shapes that are currently known, or that later become known. The compacted powder metal is preferably secured to the upper edge of the backing band 28 by compaction of the metal powder as discussed more fully below.

In FIG. 1B, an apparatus embodying the present invention for manufacturing saw blades having compacted powder metal cutting tips in near finished or finished shapes is indicated generally by the reference numeral 40. The apparatus 40 comprises a mold including a first die 42 and a second die 44 defining therebetween a die cavity 46. With reference to Step 1 of FIG. 1B, at least one of the first and second dies 42 and 44, respectively, is moved into engagement with the other to form the die cavity 46. Then, the die cavity 46 is filled with a predetermined quantity (by weight and/or by volume) of powdered metal (or “particles”) 47 used to form the work surface of the tool. As can be seen in FIG. 1B, in the illustrated embodiment, the die cavity 46 is shaped to form the cutting teeth of a saw blade, such as a band saw blade. However, as may be recognized by those of ordinary skill in the pertinent art based on the teaching herein, the die cavity 46 may be shaped to form any of numerous different wear or work surfaces of any of numerous different types of tools that are currently known, or that later become known.

In the illustrated embodiment of the present invention, the powdered metal 47 may be an engineered coated WC/Co—Ni powder, or any of numerous other engineered powder materials, such as engineered powder HSS, that are currently known, or that later become known. In the embodiment of the present invention employing engineered coated WC/Co—Ni powders, each WC particle (tungsten carbide) is preferably less than about 1 micron in diameter (or other measurable feature) and is coated with an engineered volume fraction of Co (cobalt) and Ni (nickel). Preferably, prior to coating, the WC particles are atomically clean with substantially no W oxides. When coated, a metallurgical bond forms between the WC particles and the Co—Ni coating. Preferably, the Co—Ni coating is about 100% dense. One advantage of this feature is that because substantially every WC particle is coated with Co, the diffusion distance between the Co and WC is about as short as possible. Another advantage of utilizing such engineered coated particles is that the microstructure of the resulting wear surface can exhibit a finer grain structure than encountered in prior art wear surfaces, which may in turn provide improved mechanical properties and longer wear life in comparison to the prior art.

One advantage of coating the WC particles with Ni, is that Ni is preferential to the Fe in a steel substrate, such as a blade backing, and therefore will facilitate the process of bonding the powder metal wear surface to the steel substrate, as described further below. Alternatively, the Ni can be eliminated from the WC coating, and/or the substrate, such as the blade backing, can be coated with Ni to facilitate bonding the powder metal wear surface to the substrate. Yet another advantage of employing such individually coated particles is that the parafins and de-waxing processes used in prior art methods of making carbide tipped saw blades can be eliminated, and furthermore, can facilitate achieving more densely processed particles with possible lower sintering times and/or temperatures. As described further below, the engineered particles can be coated by electrolytic co-deposition of the Co and Ni on the WC particles. Alternatively, a vapor deposition process can be employed that reduces cobalt carbonyl to substantially pure cobalt onto the WC particles. One advantage of such vapor deposition process is that it may facilitate producing WC/Co with a nanocrystalline grain structure. As may be recognized by those of ordinary skill in the pertinent art based on the teachings herein, these coating methods are only exemplary, and numerous other coating methods that are currently known, or that later become known equally may be employed.

The illustrated mold 40 is designed in two halves or dies 40, 42 that enable the manufacture of finished or near finished cutting tips. Accordingly, preferably all of the basic features of the finished tip geometry are incorporated into the die design. In one embodiment of the present invention, the dies are formed with advanced high temperature ceramic materials defining the work surface features. Preferably, the dies are CNC actuated in at least three axes (e.g., mutually orthogonal X, Y and Z axes). As indicated below, the dies also preferably include a heating and cooling system of a type known to those of ordinary skill in the pertinent art. As may be recognized by those of ordinary skill in the pertinent art based on the teachings herein, the mold 40 is only exemplary, and any of numerous other types of molds, including any desired number of parts, that are actuatable in any desired number of axes, and that are formed of any of numerous different materials, that are currently known, or that later become known, equally may be employed.

A feed system 45 of a type known to those of ordinary skill in the pertinent art may be used to fill the die cavity 46 with the coated particles 47. In one embodiment of the present invention, the feed system controls the weight, temperature and flow characteristics of the material 47. In one such system, digital manufacturing controls of a type known to those of ordinary skill in the pertinent art monitor material temperature and fluidization/shock wave frequency. In one such system, the weight and flow characteristics of the raw materials 47 fed into the die cavity 46 are controlled by controlling the frequency of fluidization. In addition, the apparent density of the raw material 47 is controlled by fluidization to control the weight of the raw material in the die cavity 46. In one embodiment of the present invention, the die cavity 46 is filled with the raw material 47 in parallel to the other heating and processing steps to minimize cycle time. In some embodiments, the feed system 45 preheats the powder metal prior to introducing the powder metal into the die cavity 46. In some such embodiments, the powder metal is preheated up to about 50% to about 75% of its sintering or melting temperature prior to or at the time of introducing the powder metal into the die cavity. In other embodiments, the powder metal is preheated up to about 50% to about its melting temperature prior to or at the time of introducing the powder metal into the die cavity. In some embodiments, the feed system 45 employs a heated fluidized bed to pre-heat and fluidize the powder metal prior to introduction of the powder metal into the die cavity 46. The feed system includes, or is coupled in thermal communication with, an external energy or heat source, such as a plasma heat source, with heated gas, such as argon gas, that heats and fluidizes the heated powder metal prior to and/or as it is fed into the die cavity. In one such embodiment, the heat source creates a heated column of argon gas that fluidizes the powder metal and preheats the fluidized powder metal. In one such embodiment, the fluidized powder metal is preheated to a temperature close to, but below, its sintering or melting temperature (e.g., up to about 50% to about 75% of its sintering or melting temperature). In another embodiment, the fluidized powder metal is preheated to a temperature up to about 50% of its melting temperature, to about its melting temperature. The fluidized preheated powder metal is transported into the die cavity 46, and is further heated in the die cavity 46. As may be recognized by those of ordinary skill in the pertinent art based on the teachings herein, any of numerous different feed systems that are currently known, or that later become known, equally may be employed to feed the raw material 47 into the die cavity 46.

With reference to Step 2 of FIG. 1B, the mold 40 includes a heating unit or energy source 49 in order to heat the raw material 47 in the die cavity 46. If desired, the same heating unit 49 may be used to preheat the powder metal prior to introduction into the die cavity as described above, or a different heating unit or energy source may be employed to preheat the powder metal. In the illustrated embodiment, the heating unit 49 rapidly heats the raw material 47 in the die cavity 46 to a temperature above the eutectic liquid phase of the raw material. Preferably, the heat rate of the raw material is relatively rapid. In one embodiment, the heat rate is about 1 KW/sec. The heating unit 49 may take the form of any of numerous different types of heating units that are currently known, or that later become known for performing this function, such as any of numerous different types of induction coil heating units, microwave heating units, E-beam sources, laser sources, RF sources, or plasma sources. If a laser, e-beam or plasma heating source is employed, it may be necessary to preheat the powder metal as described above, and/or to preheat the dies 42,44 to allow the raw material to obtain sufficient green strength upon opening the mold 40; then, the mold 40 may be opened if necessary to apply the laser, e-beam or plasma source to further heat the raw material 47 to the requisite temperature. Once the raw material 47 reaches the requisite temperature, the mold 40 may be closed again to perform the pressing Step as described further below. In some embodiments of the present invention, the die cavity 46 is flushed with nitrogen or other inert gas to provide a controlled atmosphere within the die cavity; if desired, a chamber surrounding the mold likewise may be flushed with nitrogen or other insert gas to obtain the same or similar effect. If desired, the heating of the die cavity 46 and the raw material 47 therein may be performed simultaneously with the filling Step described above, and the pressing Step described below.

In Step 3 of FIG. 1B, the heated raw material 47 within the die cavity 46 is pressed within the die cavity to both consolidate the powdered raw material to substantially full density and to bond the raw material to the substrate, such as the blade backing. In the illustrated embodiment of the present invention, the tooth portion 48 of the blade backing (i.e., the steel base of the tooth that is bonded to the powdered metal 47) is used as a punch to consolidate the raw material 47 to approximately full density in the die cavity 46. In the embodiment employing WC/Co—Ni particles 47, this occurs in the die cavity 46 as the cobalt cools from a liquid phase into a solid state phase. Simultaneously, the substrate or blade backing 48 is bonded to the raw material 47 (e.g., the WC/Co—Ni particles. The substrate or blade backing 48 also functions as a heat sink to remove heat from the raw material (e.g., the WC/Co—Ni particles) 47 during the pressing/bonding process.

In some embodiments of the present invention, the tip portion 48 of the blade backing includes one or more upsets at the pressing/bonding interface, such as one or more protuberances that extend into the raw material 47 and/or one or more recesses that receive respective portions of the raw material 47, to facilitate forming a mechanical bond at the tip-substrate interface. In one such embodiment, the upset is substantially dovetail shaped; however, as may be recognized by those of ordinary skill in the pertinent art based on the teachings herein, such an upset may take any of numerous different shapes that are currently known, or that later become known, to facilitate bonding of the powder material 47 to the substrate 48.

The density of the raw material 47 during the pressing/bonding Step may be controlled by controlling the temperature of the die cavity 46 and, in turn, the temperature of the raw material 47 received therein, the pressure applied to the raw material 47 within the die cavity 46, and the time during which the raw material is subjected to the predetermined heat and pressure. As may be recognized by those of ordinary skill in the pertinent art based on the teachings herein, the pressure within the die cavity 46 may be created in any of numerous different ways, such as by pressing at least one of the substrate/blade backing 48 and raw material 47 relative to the other, by driving one or more movable compaction or punch pins, or other pressing surfaces on the mold 40 to press the raw material 47 within the die cavity 46, and/or any of numerous other pressing mechanisms that are currently known, or that later become known. As can be seen in Step 3 in FIG. 1B, the tip portion 48 of the substrate extends into the die cavity 46 and is sealingly engaged by the opposing dies 42,44 to substantially prevent any raw material from flowing therebetween and otherwise to facilitate creating sufficient pressure within the die cavity during the pressing/bonding Step. In one embodiment of the present invention, the dies 42,44 engage the tip 48 of the substrate with sufficient pressure to coin or otherwise deform the substrate. As indicated by the arrows in Step 3, the mold 40 may be driven toward the substrate 48 to press the substrate and raw material 47 into engagement with each other. Alternatively, the substrate 48 may be driven toward the mold 40 to create the pressure, or the substrate and mold both may be driven toward each other to create the pressure. As can be seen in Step 3 of FIG. 1B, the pressing operation drives the tip portion 48 of the substrate into, or further into the mold cavity 46, and the tip portion is engaged by the opposing dies 42,44 as described above. The bond between the powdered metal 47 and the substrate is preferably controlled by controlling the pressure/density curve. This may be controlled by controlling the coating of the raw material (such as the WC/Co coating described above), the die actuation, and the punch (or tooth) actuation; the use of a Ni or other coating on the WC/Co or other particles, and/or on the backing as described above; and the atmosphere of the die cavity, such as by employing nitrogen or another inert gas.

The production rate of the apparatus of FIG. 1B can be controlled by employing multiple stations performing parallel substantially simultaneous processes. In some embodiments of the present invention, shorter sintering cycles in comparison to the prior art can lead to finer grain structures and improved mechanical properties.

The basic net shape geometry of the finished work surface, such as the WC/Co tip of the saw blade, is formed on the tooth in the press/sinter/bond process of Step 3 of FIG. 1B. Once the pressed/sintered/bonded part is ejected at the conclusion of Step 3, a grinding step may be used to sharpen molded features previously created in Steps 1 through 3. Accordingly, one significant advantage of the apparatus and method of the present invention is that the extensive grinding and sharpening encountered in the manufacture of prior art tools, such as saw blades, is significantly reduced, thus reducing the processing time and expense, and the waste of materials used to form the work surfaces.

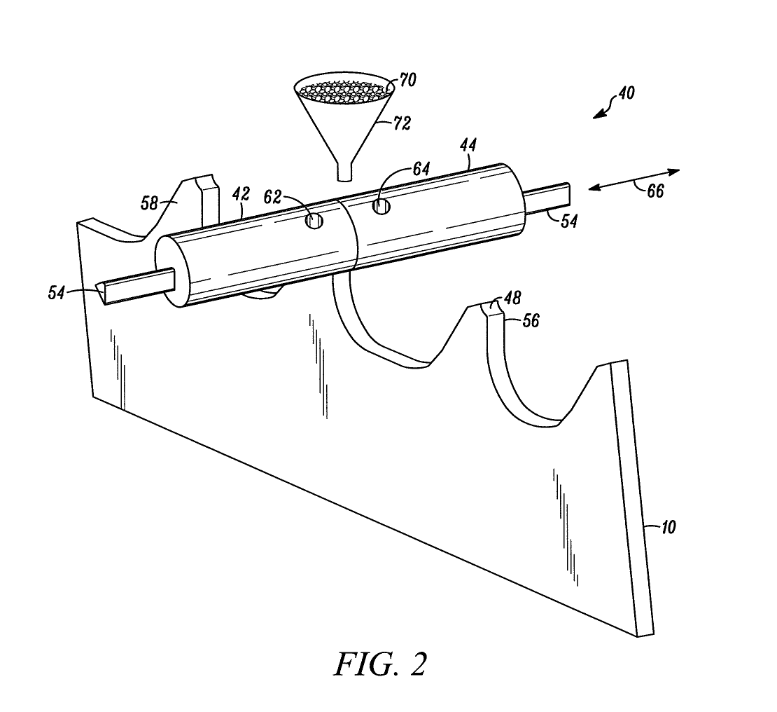

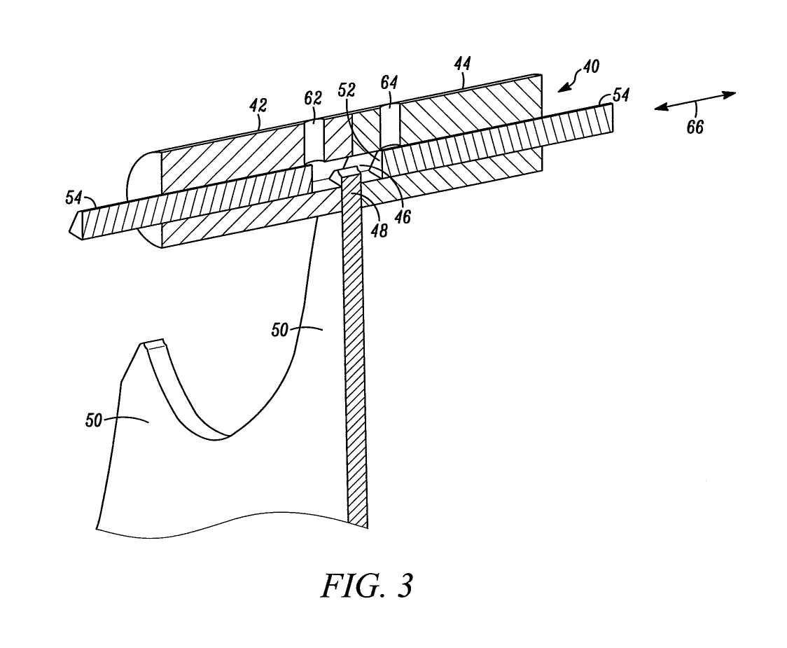

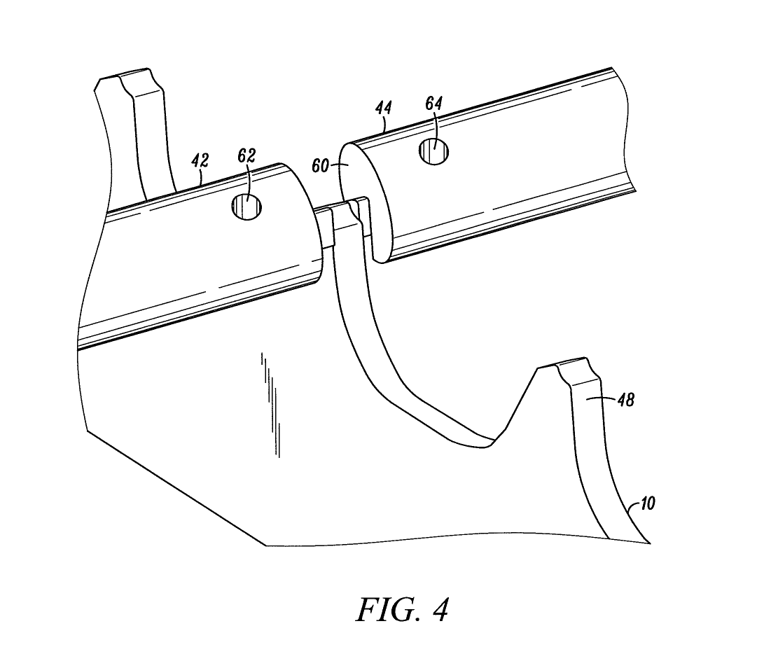

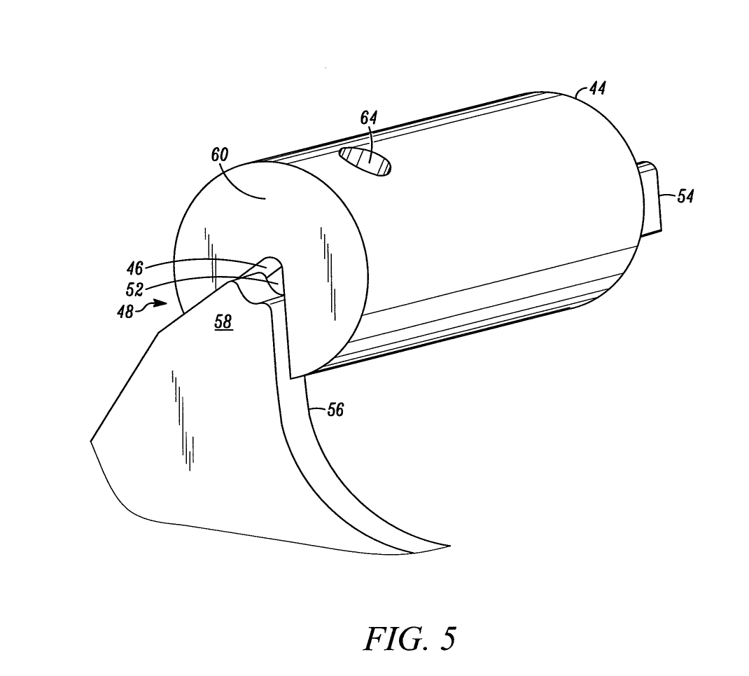

Referring now to FIGS. 2-5, another apparatus embodying the present invention for manufacturing tools having compacted powder work surfaces in near finished or finished shapes also is indicated generally by the reference numeral 40. The apparatus 40 of FIGS. 2-5 includes many features that are the same as those described above in connection with FIG. 1B, and therefore like reference numerals are used to indicate like elements. As shown in FIG. 2, the apparatus 40 includes abutting first and second dies 42, 44 defining a common axis. As best seen with reference to FIGS. 3 and 4, the dies 42, 44 are configured to define a die cavity 46 when each die is disposed about a tip portion 48 of each tooth 50. The abutting dies 42, 44 define the die cavity 46 with a configuration corresponding to that of the finished tooth profile. More particularly, the die cavity 46 is defined by a peripheral profile of an end face 52 of a respective compaction pin or pressure rod 54 translatable within a respective die 42, 44. A width dimension of the die cavity 46 is dependent on the displacement of the compaction pins 54 relative to a facing surface of each tip portion 48. As shown typically in FIG. 2, the facing surface is one of two opposing surfaces 56, 58 defining each tip portion 48. It should be noted that one half of the die cavity 46 is depicted in FIG. 5 having an end surface 60 defining one end of the die 44 that is coplanar with a plane bisecting the tip portion 48 and an abutting surface 56 of end face 52. In this manner, it will be recognized by those skilled in the pertinent art that a profile of the end face 52 defines a profile of the finished or near finished tip of each tooth 50 of a band saw blade 10. Accordingly, as described further below, the surface contour or profile of the end face 52 is set to form the surface contour of the corresponding side of the tooth tip.

As shown in FIG. 3, each die 42, 44 includes a corresponding aperture 62, 64 in fluid communication with the die cavity 46 when a respective compaction pin 54 is displaced from a corresponding surface 56, 58 defining the tip portion 48. Each compaction pin 54 is independently translatable in either direction indicated generally in FIG. 3 by a double-ended arrow 66. The apertures 62, 64 are configured to receive a powdered metal therethrough to form a finished or near finished tooth at each tip portion 48.

As shown in FIG. 4, each end surface 60 defining one end of a respective die 42, 44 is configured to provide a hermetic seal with an abutting end surface 60 of a respective die 42, 44 and surface 56, 58 of the respective tip portion 48. In an exemplary embodiment, the dies 42, 44 are biased toward one another such that they coin or otherwise deformably engage the respective tooth 50 to provide a hermetic seal with respect to the die cavity 46. In this manner, when powdered metal is disposed in the apertures 62, 64 and the compaction pins 54 are biased toward the tip portion 48, the powdered metal is compressed and prevented from escaping through the abutting die and tip portion interfaces. In an exemplary embodiment, the powdered metal, which may be preheated in, for example, a fluidized bed, flows into the die cavity 46 in a fluid manner as described above and further below.

Referring again to FIG. 2, an overview of the process for direct deposit of the edge material (e.g., powdered metal) onto the substrate (e.g., the blade backing of a band saw blade) is hereinafter described. A fully annealed backing material 10 is received and a selected gullet and tip geometry are configured in the backing material. The backing material 10 is hardened and tempered for a time depending on the mass of the product and type of furnace used. Hardening is done using a temperature slightly above the critical temperature with the goal of getting into the austenizing range. Accordingly, hardening is carried out using a temperature typically within the range of about 1850° F. to about 2150° F. depending upon the materials used. For example, relatively high alloy backings, such as 2% chromium/3% molybdenum backings, require lower hardening temperatures (about 1850° F.), whereas D6A backings require higher hardening temperatures (about 2150° F.). Tempering is carried out three times at about 1000° F. for about one hour with cooling between tempers. As may be recognized by those of ordinary skill in the pertinent art based on the teachings herein, any of numerous different heat treating processes, including the temperatures and times of such processes, that are currently known, or that later become known, equally may be employed.

Next, the backing material 10 is cleaned before direct deposit of the edge material thereto. Cleaning may include ultrasonic, abrasive, peen, and/or spray wash cleaning. Powdered metal 70 intended for use as the edge material is received in the dies 42, 44 via a feed system hopper 72. In some embodiments, the feed system preheats the powder metal prior to introducing the powder metal into the die cavity 46. Preferably, the powder metal is preheated up to about 50% to about 75% of its sintering or melting temperature prior to or at the time of introducing the powder metal into the die cavity. Alternatively, the powder metal is preheated up to about 50% to about its sintering or melting temperature prior to or at the time of introducing the powder metal into the die cavity. The feed system forms a heated fluidized bed to pre-heat and fluidize the powder metal prior to introduction of the powder metal into the die cavity 46. The feed system includes, or is coupled in thermal communication with, an external energy or heat source, such as a plasma heat source, with heated gas, such as argon gas, that heats and fluidizes the heated powder metal prior to and/or as it is transported into the die cavity. In one such embodiment, the heat source creates a heated column of argon gas that fluidizes the powder metal and preheats the fluidized powder metal. The fluidized preheated powder metal is then transported into the die cavity 46, and the powder metal is further heated in the die cavity 46. The heat source, such as the plasma source, is located below the die cavity, the heated gas, such as argon gas, flows through the heat source, through the die cavity, and in turn through the inlet to the die cavity, to fluidize and heat the powder metal as it flows through the inlet and into the die cavity. In the die cavity 46, the heated powder metal 70 (i.e., heated up to its sintering or melting temperature) is compacted by presser rods or compaction pins 54 and is, in turn, directly deposited onto the tip portion 48 of the backing material 10 to thereby form a finished or near finished tooth.

A post process edge qualification is optionally carried out when forming a near finished tooth. In other words, the now fully complete edge can be used for cutting. However, it is possible that a particular direct deposit operation will not form a sharp edge. In this case, an additional operation is required (e.g., a grind on the rake face) in order to qualify the cutting edge. Lastly, a finishing process is optionally employed that includes adding a protective material to the finished edge. In some cases, this may include adding a protective plastic edge material or coating the edge material surface before packaging.

The process to directly deposit an edge material on the blade backing 10 includes placing the blade backing 10 on a feed table (not shown) of the apparatus and threading the blade backing into an indexing portion (not shown) of the apparatus. Next, appropriate dies 42, 44 and corresponding compaction pins 54 are selected for the required tooth pitch and tip geometry. As may be recognized by those of ordinary skill in the pertinent art based on the teachings herein, the apparatus may include a plurality of different dies and compaction pins that correspond in shape to different teeth geometries, or other tool geometries, that may be retained and interchangeably used with the apparatus. The powdered edge material 70 is loaded into the feed hopper 72. A first tooth 50 is indexed into an area defined by the die cavity 46. The dies 42, 44 are then axially translated toward one another to abut each other and close the die cavity 46 onto the tip portion 48 of the respective tooth 50. The die cavity 46 is then filled with powdered edge material 70 from hopper 72 via apertures 62, 64. The powdered edge material 70 is compacted via actuation of the compaction pins 54. Compaction pressure is reduced to a level adequate for ejection when the dies 42, 44 are retracted, while the compaction pins 54 remain in contact with the tooth tip portion 48 to facilitate withdrawal of the dies.

When the dies 42, 44 are retracted, a sintering heat is applied to the edge material while the compaction pins are still engaged with tip portion 48. In another embodiment of the present invention, the heat is applied to an entire portion of the tip that is defined by the deposited powdered edge material 70. Alternatively, as described above, heat may be applied to the edge material with the die in the closed state. Heat is applied via induction, laser, or microwave energy, for example, but is not limited thereto. The goal at this point is to fully sinter the edge material 70 as well as form a bond between the edge material and the substrate 48. It will be noted that although heating just the edge material 70 will suffice, inevitably, the substrate 48 to which it is applied will be heated as well. In other words, the near net or net shaped tip is formed on the substrate 48 such that the substrate is the core of the tip. The selected temperature and time are dependent on the desired end purpose and materials employed. However, it will be noted that in the case of bonding sintered carbide to a spring steel backing material 10 (e.g., Cr/Mo mix defining a hardness of about Rc 45-52), the selected temperature and duration should be such that no melting and recasting of the backing steel is permitted. In other words, the weld zone interface should be ductile. In another embodiment, the heat may be applied solely to an interface area between the tooth tip portion 48 and the deposited edge material.

In an exemplary embodiment, it is contemplated that the edge material is a conventional material including about 10% simple cobalt tungsten carbide. However, it is envisioned that “engineered materials” or available “bridge” HSS materials also may be used. As may be recognized by one of ordinary skill in the pertinent art, any one of numerous different materials that are currently known or that later become known may be used.

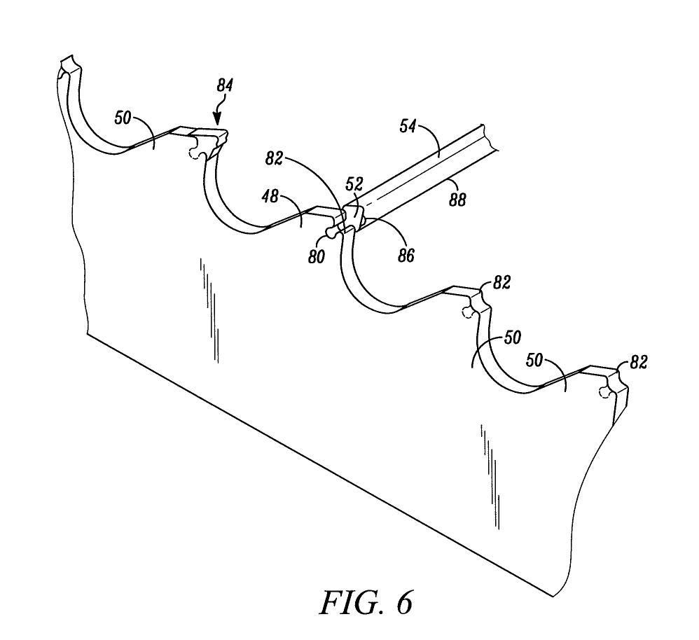

FIG. 6 illustrates one of the tip portions 48 having an upset or interlock feature 80 configured as a substantially dovetail-shaped recess 80 extending inwardly from a concave portion 82 defining a tip of each tooth 50. The upset or interlock feature 80 provides a mechanical interlock for the deposited edge material 70. In this manner, the metallurgical bond at an interface between the substrate (e.g., the backing material 10) and deposited edge material 70 is buttressed with a mechanical interlock, thereby avoiding sole reliance on a metallurgical bond. It will be recognized by those skilled in the pertinent art that the upset or interlock 80 may take the form of any of numerous different shapes suitable to the desired end purpose, such as any of numerous different protuberances or recesses in any of numerous different shapes.

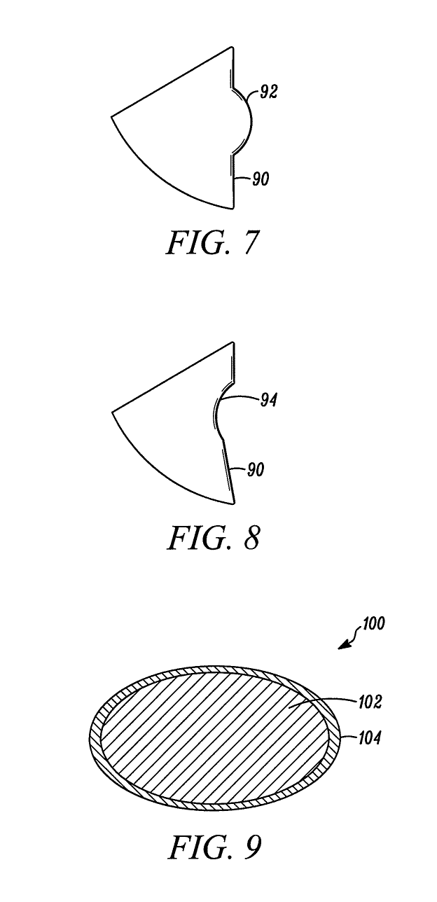

FIG. 6 further illustrates the axially translatable compaction pin 54 for compressing powdered metal 70 within the cavity 46 and defining one side of a net or near net shape cutting tip of each tooth 50. The pin 54 is defined at one end with a compression face 52 that defines a tool tip shape generally indicated at 84. In the exemplary embodiment of FIG. 6, a peripheral contour of the compression face 52 defines the tool tip shape of a net or near net shape tooth. For example, a leading edge 88 defined by the face 52 of pin 54 can alternatively be configured to have a protrusion 86 extending therefrom and corresponding to a leading edge 90 of the tooth 50, as illustrated in FIG. 6, or to provide a chip breaker 92, as illustrated in FIG. 7. FIG. 8 illustrates another exemplary embodiment of a net or near net shape tooth profile having a minimized surface area generally indicated at 94 for contacting chips and made possible by the above-described system and method. FIG. 8 is representative of a tooth profile geometry that is currently not capable of being formed by conventional/grinding processes.

Although the above system and method have been described with reference to the production of carbide tipped band saw blades, it is contemplated for use with other types of band saw blades, high speed steel blades, circular saw blades, hole saw blades, reciprocating or recip blades, any of numerous other types of saw blades, and any of numerous other types of tools, such as screwdrivers, pliers, wrenches, etc., that may define any of numerous different wear or work surfaces formed with any of numerous different types of materials in any of numerous different shapes. Indeed, it is envisioned that any product that requires a r wear or work surface may benefit from the above described apparatus and process.

Although the powder 70 in hopper 72 (FIG. 2) has been described as a powdered metal, the powder may include, but is not limited to, ferrous powder, fluidized powder, powders treated with aqueous solutions, and coated particles having engineered properties. Various engineered properties of coated particles, as well as treated powders, ferrous powders and fluidized powders, that can be used in connection with the apparatus and method of the present invention, are disclosed in U.S. Pat. No. 5,820,721 to Beane et al., U.S. Pat. No. 6,042,781 to Lashmore et al., U.S. Pat. No. 6,251,339 to Beane et al., U.S. Pat. No. 5,885,496 to Beane et al., U.S. Pat. No. 5,885,625 to Beane et al., U.S. Pat. No. 5,945,135 to Beane et al., U.S. Pat. No. 5,897,826 to Lashmore et al., and U.S. Pat. No. 6,241,935 to Beane et al., each of which is hereby expressly incorporated by reference in its entirety as part of the present disclosure.

### Coated Particles Having Engineered Properties

As described above, the powdered edge material 70 may take the form of coated particles having engineered properties. In some such embodiments, each coated particle is made from a first material and is coated with a second material so that the ratio of the volume of the coating relative to the volume of the particle is substantially equal to a selected volume fraction. The first and second materials and the volume fraction preferably are selected to cause the coated particles to exhibit at least one selected intrinsic property that is a function of intrinsic properties of the first and second materials. The first material may be, for example, tungsten, tungsten carbide, molybdenum, graphite, silicon carbide, or diamond. The second material may be, for example, cobalt, nickel or copper. Through this process a coated particle is manufactured that has one or more engineered intrinsic properties (such as hardness, toughness, thermal conductivity or coefficient of thermal expansion) that are different from the intrinsic properties of the first and second materials themselves. The plurality of coated particles (possibly mixed with other particles) are then consolidated to cause all of the particles to be joined to each other to form a work or wear surface (e.g., a cutting edge as described above). As discussed above, the coated particles are consolidated by compaction and solid-state or liquid-phase sintering. Sintering causes the second material to form bonds between adjacent particles. The compacted work surface may be solid-state sintered (sintered at a temperature below the melting point of the particles and the melting point of the coatings of the particles) or alternatively may be liquid-phase sintered (sintered at a temperature above the melting point of the coatings but below the melting point of the particles). The sintering causes bonds to form between the particles to provide a heterogeneous work surface. The coating of the particles thus serves as a “matrix material” (a material that holds the particles together, forming the work surface).

With reference to FIG. 9, an exemplary particle 102, which may be as small as a few microns in diameter, and which includes an elemental metal, a metal alloy, or a non-metal, is covered with a coating 104 of an elemental metal, metal alloy, or non-metal to form a coated particle 100. The coated particle 100 may exhibit engineered intrinsic physical properties (e.g., thermal conductivity or coefficient of thermal expansion) and/or intrinsic mechanical properties (e.g., hardness, toughness, and tensile strength). The intrinsic physical properties (but not the intrinsic mechanical properties) of each coated particle 100 tend to behave in accordance with the Lacce Rule of Mixtures, according to which the intrinsic physical properties vary approximately linearly with respect to the ratio of the volume of coating 104 to the volume of particle 102. Mechanical properties may vary non-linearly with the ratio of the volume of coating 104 to the volume of the respective particle 102.

The coating 104 is adherently applied to the particle 102 by, e.g., electroless deposition (a technique discussed in U.S. Pat. No. 5,820,721 to Beane et al., the content of which is incorporated herein by reference in its entirety). The intrinsic properties of each coated particle 100 are engineered by controlling the volume fraction of the coating 104 relative to the particle 102, which can be accomplished in at least two ways: 1) by controlling the size of the particle 102, or 2) by controlling the thickness of the coating 104.

In one embodiment, the particle 102 includes, for example, elemental tungsten, the coating 104 includes elemental copper, and the volume fraction of copper to tungsten is about 27%-to-73%. Copper has a high thermal conductivity of approximately 391 w/m ° K (watts per meter-degree kelvin) and a relatively high coefficient of thermal expansion of approximately 17.5 ppm/° C. (parts per million per degree centigrade) through the temperature range of 25° C. to 400° C., whereas tungsten has a relatively low thermal conductivity of approximately 164 w/m ° K. and a relatively low coefficient of thermal expansion of approximately 4.5 ppm/° C. through the range of 25° C. to 400° C. An exemplary copper-coated tungsten particle 100 has a thermal conductivity of approximately 226 w/m ° K at 25° C. (intermediate between the high thermal conductivity of copper and the lower thermal conductivity of tungsten) and an engineered coefficient of thermal expansion of approximately 8.2 ppm/° C. (intermediate between the low coefficient of thermal expansion of tungsten and the higher coefficient of thermal expansion of copper) through the range of 25° C. to 400° C.

The mold 40, including the dies 42, 44 and compaction pins 54 of FIG. 2, may be employed to consolidate the coated particles 100 into a wear or work surface on a substrate such as backing material 10.

Other embodiments of coated particles 100 are contemplated and are within the scope of the claims. For example, there are numerous materials out of which particles 102 and coatings 104 (FIG. 9) may be formed. Particles 102 may consist of, e.g., tungsten, tungsten carbide (WC), molybdenum, graphite, silicon carbide, diamond, nickel 42, KOVAR, or a ceramic, and coating 104 may consist of, e.g., copper, aluminum, cobalt (Co) or nickel (Ni).

The coating may even be a non-metal (e.g., a glass, oxide, ceramic, resin, polymer, or other organic such as silicone), provided that the coating material is capable of fusing to form bonds between the particles, and provided that neither the coating material nor the material out of which the particles are formed melts at a temperature lower than that at which the coated particles are fired to cause the non-metal coatings to fuse together. Particles may be coated with such a non-metal coating by placing the particles in a slurry of the non-metal material and then removing the particles from the slurry, the particles being sized such that when the coated particles are removed from the slurry the coated particles have a selected volume fraction of coating to particle material. The coated particles are then consolidated and/or fired, causing the coatings to vitrify or fuse together.

Graphite and diamond are good materials from which to form particles 102 where the work surface being manufactured must have a low coefficient of thermal expansion and a high thermal conductivity, because these materials not only have a low coefficient of thermal expansion (as do tungsten and molybdenum) but also have a relatively high thermal conductivity (unlike tungsten and molybdenum). Consequently, these materials have the advantage that they do not have the adverse side-effect of reducing thermal conductivity of the coated particles and articles and coatings formed from the coated particles.

It is possible to engineer many intrinsic properties other than thermal conductivity or coefficient of thermal expansion. For example, the electrical conductivity of a work surface, wear surface or other surface may be engineered in combination with the engineering of other intrinsic properties. Thus, in one embodiment, the choice between using graphite particles (which are electrically conductive) and diamond particles (which are electrical insulators) is based on the desired electrical conductivity of the compacted powder surface.

It is also envisioned that particles 100 need not consist entirely of coated particles. Alternatively, a mixture of coated particles combined with other particles (e.g., copper-coated tungsten particles can be combined with copper particles) may be thoroughly mixed and then compacted to form a wear surface on an article, such as a tool tip, for example, having intrinsic properties that are a function of the volume fractions of all of the materials in the mixture, the wear surface exhibiting the intrinsic properties isotropically. Alternatively, the coated particles can be combined with materials that exhibit one or more intrinsic properties anisotropically, causing the wear surface in turn to exhibit one or more intrinsic properties anisotropically. For example, the coated particles can be mixed with crystalline materials that have properties that differ in different directions, the crystalline materials being mixed with the coated particles in a manner such that the crystalline materials tend to be oriented in a common direction. In another example, the coated particles are mixed with carbon fibers, the carbon fibers tending to be oriented in a common direction. The carbon fibers provide tensile strength that varies with respect to direction.

As discussed above, the coated particles have utility in a wide variety of applications. The coated particles may be compacted under pressure to form a net shaped or near net shaped work or wear surface. Compaction may be accomplished for manufacture of wear surfaces from coated particles, for example, by metal injection molding, hot pressing, hot isostatic pressing (“hipping”), cold isostatic pressing (“cipping”), hot or cold isostatic forging, hot or cold roll compacting (which “densifies” consolidated coated particles), coining, forging, powder injection molding, die casting, or other powder metallurgy techniques that are currently known, and that later become known.

### Powders Treated with Aqueous Activation Solution

Alternatively, the powdered material 70 may be treated with an aqueous activation solution and pressure applied to consolidate the treated material into a net or near net shape at or near ambient temperature. In many instances, no further processing steps, in particular high temperature sintering, may be needed to produce a fully dense, well bonded, net or near net shape work or wear surface.

The process comprises treating the powder material with an aqueous activation solution and using pressure to consolidate the treated material into a net or near net shape at or near ambient temperature. Metal alloys appropriate for this process (and as edge materials for other materials) include, but are not limited to alloys of iron (e.g. steel), for example. Exemplary materials that can be coated with an appropriate metal or alloy and then consolidated to a net shape or near net shape work surface, include powders, particulates, sheets or foils of stainless steel, zinc, iron, titanium, hafnium, molybdenum, tantalum, niobium, vanadium, zinc, gallium, lanthanum, rhenium, tin, yttrium, scandium, thorium, cerium, praseodymium, neodynium, samorium, gadolinium, terbium, holmium, erbium, thulium, ytterbium, lutetium, graphite, diamond, tungsten, aluminum, silicon carbide, tungsten carbide, molybdenum, titanium, nickel, and iron. As demonstrated by the foregoing list, certain materials such as nickel can be consolidated coated or uncoated or can themselves be used as a coating. All of the aforementioned materials can be initially provided with the respective coating of a metal such as nickel, cobalt, or copper, or alternatively, the present disclosure can comprise the optional step of coating the respective material to be consolidated prior to treating it with the activation solution.

The materials to be consolidated are treated with an aqueous activation solution to prepare their surfaces to cold weld to each other under pressure at ambient temperature. The aqueous activation solution should preferably be comprised of one of an acid, a reducing agent, mixtures thereof or a molten salt electrolyte. The nature and specific concentration of each respective component of the activation solution depends on the nature of the application, i.e. the specific material being cold-welded and the specific properties required of the resultant work or wear surface.

Any aqueous media can be used as the solvent into which the acid or reducing agent is dissolved to produce the aqueous activation solution. Suitable solvents include, but are not limited to, water, oil, methanol, toluene, benzene, nitric acid, ethanol, hydrochloric acid, hydrofluoric acid, hydrobromic acid and molten salts such as chloroaluminate and methylzolium chloride. In some embodiments, acidified water is preferred as the solvent for the activation solution.

Appropriate acids for use in the aqueous activation solution, include, but are not limited to, fluoboric acid, sulfuric acid, hydrofluoric acid, hydrochloric acid, citric acid, adipic acid, ascorbic acid, sodium ascorbate, potassium ascorbate, sulfamic acid, ammonium biflouride, nitric acid, acetic acid, acetoacetic acid, anisic acid, ascorbic acid, benzoic acid, hydroiodic acid, hydrobromic acid, and mixtures thereof. In all instances, the pH of the acid should preferably be equal to or near its pKa. Further, the preferred range of concentration for the acid in the aqueous solution should be from about 0.1% to about 10% by weight, at a temperature of from about 25° C. to about 50° C. The controlling characteristic should be the pH of the acid in the solution, hence all other parameters should be adjusted to ensure the appropriate pH of the acid in solution.

Once treated, the powders are consolidated into a net or near net shape work or wear surface having increased green strength (increased to eliminate the need for a high temperature sintering step). Additionally, prior to consolidation, metallic and/or non-metallic hard components such as oxide, carbide or nitride particles in the form of high-strength structural whisker, particulate, fiber or wire additives can be incorporated into the mixture. Such additives may also include, but are not limited to, alumina powder, silicon carbide powder, graphite, diamond, sapphire, boron carbide, tungsten carbide or the like. Other whisker, fiber or particle additives are also within the scope of the present disclosure.

The pressure used to consolidate the material of choice into a net shape or near shape work or wear surface can be provided by the die presses illustrated in FIG. 1B or FIG. 2. When the step of consolidating the material takes place in the die cavity of such a powder press, the preferred pressure for consolidating the material to a cohesive solid ranges from about 20 Kpsi to about 120 Kpsi. The specific pressure used will vary with the material being consolidated, the complexity and the desired density of the work or wear surface being made and the load rate of the press. Some materials are load rate sensitive, such as copper coated aluminum and ferrous alloys. In such instances, preferred loading rates (speed of compaction pins 54 or die punch) should be from about 0.5 mm/second to about 100 mm/second.

The liquid present between the suitably treated materials is forced out from between the powders, particulates, foils or sheets during the consolidation step by the pressure generated during compaction. Alternatively, the liquid can be removed prior to the actual consolidation by any appropriate means for doing so, as for example by vacuum. The liquid, in addition to enabling the particles to weld to each other provides a very important secondary benefit by constraining very small powder particles under the surface of the liquid so that they can be handled more safely.

Accordingly, the present disclosure is also directed to a process for imparting the ability to consolidate to a net shape or near net shape work surface having increased green strength under pressure at ambient temperature, or at relatively low sintering temperatures above ambient, to a particulate non metal, metal, metal alloy or intermetallic material. The process comprises the steps of adding to the material an amount of aqueous activation solution in a concentration and at a pH sufficient to impart to the particulate material the ability to form a net shape or near net shape work surface having increased green strength when pressure is applied thereto. The activation solution comprises an acid, a reducing agent, or mixtures thereof, as in previously described embodiments, or a molten salt electrolyte. The choice of appropriate pH and concentration of the acid, reducing agent and molten salt electrolyte for these embodiments is also the same as that described in detail above for other embodiments and described in U.S. Pat. No. 6,042,781 to Lashmore et al., which is expressly incorporated herein by reference in its entirety.

### Particulate Ferrous Material

For purposes of this disclosure “ferrous” is intended to include all iron materials including alloys of iron as well as pure iron and all steels. The present disclosure further contemplates a method for increasing the green density of work or wear surfaces by pressing powders of materials, such as ferrous materials, that work harden rapidly, are hard themselves, and/or point to point “weld” upon compaction. Furthermore, since the method does not require a high temperature sintering step, it can readily be used to make work or wear surfaces of tools having complex geometries and tight dimensional tolerances.

In one embodiment, the method includes providing a quantity of particulates of a material that welds upon compaction, such as a ferrous material or materials that are themselves hard, as for example steel; electrochemically depositing a layer of from about greater than about 0 wt % to about 50 wt %, and preferably less than about 2 wt %, of ductile metal or alloy onto each of said particulates. The metal acts as a lubricant and/or acts to eliminate welding of particle to particle and particle to die wall. The thus plated or coated particulates are then consolidated under pressure to form a wear surface deposited on a tool substrate, and the wear surface and interface therebetween are heated. By using such relatively low temperatures in the heating step, and by starting with a higher density material, the consolidated wear surface is not distorted in shape as it otherwise might be by traditional high temperature sintering.

One advantage of this method is that it avoids the shape distortion problems associated with prior art high temperature sintering of powder metallurgy parts by providing a process whereby pressed work surfaces can be heated at relatively low temperatures because a) the substantially uniform metallurgical coatings on the particles provide lubricity and therefore allow the parts to be pressed to higher than traditional green densities, thus higher temperatures are not needed to collapse internal porosity in the green part and increase its density, and b) the uniform coatings around each particle allow for shorter diffusion distances between the metal coating material and the core particle thus eliminating the need for higher temperatures to promote homogeneity in the finished work surface.

As a first step, a substantially uniform metallurgical layer of from greater than about 0 wt. % to about 50 wt. %, (and for some applications, e.g., lubrication, this may be less than about 2 wt. %) of ductile metal or alloy is electrochemically deposited onto each of said particulates. For purposes of this disclosure, “particulates” should be interpreted to include powders, whiskers, fibers, continuous wires, sheets and foils. Suitable ferrous materials for use in this process, include, but are not limited to, iron, steels, stainless steels, as for example, but not limited to M2 (0.85C, 0.34Mn, 0.30Si, 4.0Cr, 2.0V, 6.0W, 5.0Mo), M4 (1.30C, 0.30Mn, 0.30Si, 4.0Cr, 4.0V, 5.5W, 4.5Mo), S7 (0.5C, 1.4Mo, 3.25Cr) and 52100 steel alloys.

The coating can be done by any method known in the art for providing uniform metallurgical coatings on metal powders. In some embodiments, the coating step is done by electrochemical deposition, such as by electroplating, to ensure as uniform a layer of the metal material on the particulate ferrous material as possible. One requirement is that the metal coating be a true metallurgical coating. Hence, any known coating process (e.g., sputtering, CVD or chemical reduction) or electroplating can be used to coat the particles. One process for plating the layer of ductile metal or alloy onto the particulates uses a fluidized bed apparatus of the type disclosed in U.S. Pat. No. 5,603,815 to Lashmore et al., which is hereby expressly incorporated in its entirety by reference herein.

Generally, any known ductile materials are appropriate for use. The appropriate coating material should be chosen for its ability to “lubricate” the ferrous particulates during consolidation. Additionally, the coating material can be chosen for its properties, such as mechanical, tensile, strength, etc. By coating the iron (or steel) particles with materials that have other desirable properties, the disclosed process can be used to engineer or improve properties of work or wear surfaces made from iron (or steel) powders in addition to increasing green density. Cobalt, nickel, copper, titanium, and zinc and are generally chosen for their ability to solubilize into the core material and to impart superior mechanical properties to the final part.

In one exemplary embodiment, the particulate can be steel (for strength) and the coating material can be cobalt (for lubricity and mechanical properties). Hence, in such an instance, the process can provide for the production of a fully dense green part having both the superior tensile strength of steel and the superior mechanical properties of cobalt. Those of ordinary skill in the pertinent art can envision based on the teachings herein any of numerous appropriate combinations for particulate and coating materials and their respective properties, and the disclosure should therefore not be construed to be limited to selecting materials for strength and mechanical properties only, or limited to ferrous metals or in fact metals at all. Metallic coated ceramics should also be within the purview of the present disclosure. The degree to which the finished work or wear surface will exhibit one or both of the respective properties will depend on the relative thickness of the coating material on the particulate.

Once coated, the particulates are consolidated to form a wear surface on the substrate and heated at a temperature of from about 200° C. to about 800° C., for a period of from about 10 minutes to about 10 hours. Preferably, the temperature is from about 300° C. to about 550° C. and the time period is from about 20 minutes to about 180 minutes. In this process, the appropriate temperatures and times for this heating step should in general be selected to be high enough to cause the coating material to diffuse into the core (particulate) material, while being low enough to prevent the distortion of the substrate upon which consolidated particulates are deposited.

Although any source of pressure may be suitable to consolidate or compact the powders, the consolidation step is preferably done in the die cavity of a powder press as illustrated, for example, in FIG. 1B or FIG. 2.

The subject method is particularly suited for making ferrous and other metal work or wear surfaces having complex geometries by powder metallurgy, since high temperature sintering is not required. An example of such a metal work surface is the work surface of an adjustable wrench, such as the single or double toothed jaws of a wrench. Another example of such a metal work surface includes the drive surface or head of a screwdriver, such as a Phillips head, slot head or other type of screwdriver. Such parts are traditionally machined to avoid shape distortion due to high temperature sintering. In some embodiments the properties of an iron or steel work surface made by powder metallurgy are engineered. It is also contemplated that a ferromagnetic powder may be employed for such tool tips or other work surfaces. If desired, such tool tips could be provided with magnetic properties such that the tool tip interfacing with a metal fastener (e.g., a bolt) is not lost once the fastener is removed.

In all of the aforementioned embodiments, the heating step (annealing) should preferably be done in a reducing atmosphere or in a neutral oxygen free atmosphere. Such an atmosphere can be provided by nitrogen, hydrogen, argon or other inert gas. By annealing the consolidated work surface in a reducing atmosphere, the production of iron oxide is prevented.

### Fluidized Particulate Matter

The present invention can further employ a method of creating a substantially uniform density distribution of particulate material within the die cavity of a powder press. The method comprises delivering a quantity of particulate material to the die cavity and fluidizing the particulate material prior to introduction into the die cavity, and/or within the die cavity, to substantially evenly distribute the particulate material so that it is substantially uniform in density throughout the die cavity. The fluidizing step may comprise sealing a fluidized bed in fluid communication with the die cavity for introducing the preheated fluidized powder metal into the die cavity, and/or the die cavity from the ambient atmosphere and thereafter applying a series of at least one pressure pulse into the interior of the fluidized bed and/or die cavity. The series of pressure pulses may be within the range of about 2 to about 100 pressure pulses, each of which comprises delivering supra-atmospheric pressure into the sealed fluidized bed and/or die cavity and thereafter exhausting the pressure from within the fluidized bed and/or die cavity. In some embodiments, the fluidization step comprises delivering pressure to the fluidized bed and/or die cavity within the range of about 1 pound per square inch (“psi”) to about 150 psi, for a time period of about 10x seconds, and exhausting the pressure at least once for a time period of about x seconds. In some such embodiments, the pressure pulses are delivered to the fluidized bed and/or die cavity at pressures within the range of about 1 psi to about 150 psi, for a time period within the range of about 0.01 seconds to about 60 seconds, and thereafter exhausting the pressure at least once for a time period within the range of about 0.01 seconds to about 60 seconds. Supra-atmospheric pressure is optionally applied simultaneously or substantially simultaneously with the powder delivery to push the particulate material into the fluidized bed and/or die cavity.

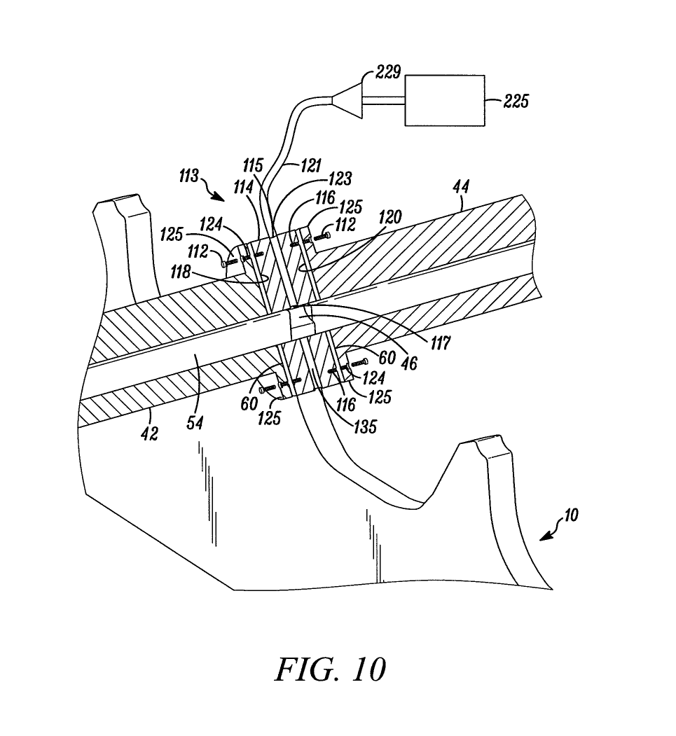

Referring to FIG. 10, the salient features of a gravimetric pulsed feed powder delivery system for feeding and delivering a precise amount of powdered metals into a die cavity are shown. The powdered metals (not shown) are substantially uniformly delivered using pressure to push a mass of powder into all regions of the die cavity 46, and the delivered powdered metals are compacted by actuation of the compaction pins 54 or other compacting mechanism. Metal powders are being described for illustrative purposes only, and the teachings of this disclosure should not therefore be construed as being limited to handling of metal powders, but are equally applicable to the handling and delivery of particulate materials of various weights and types, including without limitation, for example, flakes, powders, fibers or sheets of ceramics, polymers, carbides and cements (cementatious materials blended with water).

The powder feed system of FIG. 10 is provided for delivering a quantity of particulate material to a die cavity of a powder press. As described above in connection with FIG. 2, the powder press includes opposing dies 42, 44 each having a corresponding translatable compaction pin 54 which define sidewalls of the cavity 46 and a peripheral profile of a resulting net or near net shaped work surface. The powder delivery system as shown in FIG. 10 comprises a receptacle 113 for receiving and delivering particulate material to the die cavity 46 and defined by an interior cavity formed by an inner wall of receptacle 113. The receptacle 113 is connected to the die surfaces 60 by any suitable connector, such as bolts 112. The bolts 112 extend through receptacle holes 124 in flanges 125 extending from the dies 42, 44 and defining a periphery of the respective die surface 60, and in turn extend through threaded holes 116 of the receptacle 113. The receptacle 113 has an ingress 115 through which a mass of particulate material is received under pressure, and an egress 117 that registers and communicates with the die cavity 46 and through which particulate material is pushed under pressure from a feed conduit 121 into the die cavity 46. The feed conduit 121 is sealingly attached at a first end 123 to the receptacle ingress 115.

In FIG. 10, the pressurized powder feed system is shown to have an annular shaped receptacle 113, and comprises an annular receptacle body 114 that surrounds and defines the interior void corresponding to the die cavity 46. The receptacle body 114 has sides 118 and 120 sealingly attached to corresponding die surfaces 60. An exhaust portal 135 extends through the receptacle body 114 for releasing pressure from within the die cavity 46.

FIG. 10 schematically illustrates a pressure generator 225 that provides supra atmospheric pressure to push particulate material from a vessel 229 through the feed conduit 121 and into the die cavity 46, and for optionally fluidizing particulate material within the die cavity 46 to create a substantially uniform density distribution of particulate material within the die cavity. The feed conduit 121 is preferably made from a material which does not generate static electricity. It has been found that a tube of conductive Teflon material with graphite flakes dispersed therein situated inside of a stainless steel sleeve for grounding purposes is useful. However, any non-static or substantially non-static material that is currently known, or that later becomes known, is suitable for use as the feed conduit.

The exhaust portal 135 allows for the release of pressure from within the die cavity 46 as pressure is used to push the powder into the cavity, and also can be used in conjunction with pulses of pressure to fluidize the powders within the die cavity. A powder shot is optionally weighed and pushed from behind under pressure into the die cavity 46, and fluidized once inside the die cavity (which is caused to behave fluid-like in nature), thereby substantially uniformly filling all regions in the die cavity to substantially uniform density.

The fluidizing step serves to level the powder inside the die cavity 46 so that it has a substantially uniform density throughout the die cavity. This fluidizing step can be performed independently of the pressurized powder delivery step, and thus can be used in traditional powder feed methods and feed shoes wherein a shuttle simply drops powder into the die cavity. For purposes of the present disclosure, fluidization can be carried out by any number of methods and can include, but should not be construed as limited to, pressurizing and exhausting the die cavity, agitating the filled die cavity by vibration (ultrasonic, sonic, shockwave, electric field, magnetic pulses, etc.) or by adding the powder blended with a liquid component to the die cavity (e.g., aqueous activation solution as discussed above). Such liquid could be subsequently removed by evaporation, suction, vacuum or forced out by pressure.

In some embodiments the fluidizing step comprises fluidizing and preheating the powder metal prior to introducing the powder metal into the die cavity. In some such embodiments, the powder metal is preheated up to about 50% to about 75% of its sintering or melting temperature. In other embodiments, the powder metal is preheated up to about 50% of its sintering or melting temperature to about its sintering or melting temperature. In either case, the fluidized powder metal is heated to its sintering or melting temperature prior to compaction within the die cavity. A heated fluidized bed pre-heats and fluidizes the powder metal prior to introduction of the powder metal into the die cavity. An external energy or heat source, such as a plasma heat source, with heated gas, such as argon gas, heats and fluidizes the powder metal as it is transported into the die cavity. The plasma heat source creates a heated column of argon gas that fluidizes and heats the powder metal as it is transported into the die cavity. In some such embodiments, the heat source, such as a plasma heat source, is mounted below or otherwise in thermal communication with the die cavity. The gas, such as argon gas, flows through the heat source, through the die cavity 46, and in turn into the inlet to the die cavity (i.e., the inlet extending between the ingress 115 and egress 117 of FIG. 10), to fluidize the powder metal in the inlet and die cavity, preheat the powder metal in the inlet, and continue to and/or further heat the powder metal in the die cavity. In one such embodiment, the heat/gas source is coupled in fluid communication with the portal 135 of FIG. 10 to allow the heated gas to flow up through the exhaust portal and, in turn, up through the die cavity and inlet to fluidize and heat the powder metal as described above. In this alternative embodiment, the pressure generator 225 may be eliminated, if desired or practicable, and the powder metal is fed by gravity from the hopper or like vessel 229 into the inlet where the powder metal is fluidized and preheated as described above.

As may be recognized by those of ordinary skill in the pertinent art based on the teachings herein, numerous changes and modifications may be made to the above-described and other embodiments of the present invention without departing from the scope of the invention as defined in the appended claims. For example, the work or wear surface, such as a tool tip or teeth, may take any of numerous different shapes, forms, tool types, of work or wear surfaces that are currently known, or later become known. In addition, the substrate may be formed of any of numerous different materials or may take any of numerous different configurations, tool types or shapes, and the wear surfaces or work surfaces may be formed of any of numerous different materials, that are currently known or that later become known. For example, in a band saw blade embodiment, the band may define a bi-metal construction wherein each tooth defines a cutting tip formed of a relatively hard, powdered metal, such as high speed steel, carbide, and/or cermet, for improved wear resistance and cutting life, and the backing portion of the band may be formed of a less hard spring steel for improved toughness and durability. Further, many of the specific angles, dimensions, ranges, and other detailed features disclosed herein are only exemplary, and may be changed as desired or otherwise required to achieve particular performance characteristics or otherwise to meet the requirements of one or more applications. Accordingly, this detailed description of the currently preferred embodiments is to be taken in an illustrative, as opposed to a limiting sense.

What is claimed is:

1. A method of forming a tool having a compacted powder work surface, comprising the following steps:
providing a tool substrate;
moving at least one die surface into engagement with the substrate and forming a die cavity substantially enclosing at least a portion of the substrate;
introducing powder metal into the die cavity;
heating the powder metal;
compacting the powder metal and forming a near net shape or net shape compacted powder work surface within the die cavity and bonded to the substrate; and
disengaging the at least one die surface from the substrate and forming a compacted near net shape or net shape compacted powder work surface on the substrate.

2. A method as defined in claim 1, wherein the compacting step includes applying pressure to the compacted powder metal within the die cavity, and further comprising heating at least an interface between the substrate and the compacted powder metal while applying pressure to the compacted powder metal within the die cavity.

3. A method as defined in claim 1, wherein the compacting step includes moving at least one of the at least one die surface and the substrate toward the other to press at least one of the substrate and powder metal into engagement with the other and, in turn, press the compacted powder metal within the die cavity.

4. A method as defined in claim 3, wherein the compacting step further includes driving the substrate at least partially into the die cavity and pressing the compacted powder metal within the die cavity.

5. A method as defined in claim 4, wherein the at least one die surface deformably engages the substrate.

6. A method as defined in claim 5, wherein the at least one die surface engaging the substrate forms a substantially hermetic seal between the die cavity and substrate.

7. A method as defined in claim 1, further comprising forming an upset at an interface of the substrate and powder metal that mechanically interlocks the substrate and powder metal.

8. A method as defined in claim 7, wherein the upset is defined by at least one of a protuberance and a recess formed on the substrate at an interface between the substrate and powder metal.

9. A method as defined in claim 8, wherein at least one of the protuberance and recess is substantially dove-tail shaped.

10. A method as defined in claim 1, wherein the heating step includes at least one of (i) preheating the powder metal prior to introduction into the die cavity; (ii) preheating and fluidizing the powder metal prior to introduction into the die cavity; (iii) heating at least one die surface and, in turn, heating the compacted powder metal within the die cavity; and (iv) disengaging the at least one die surface from the compacted powder metal and heating the compacted powder metal.

11. A method as defined in claim 10, wherein the heating step includes directing energy from at least one of a laser source, a RF source, a microwave source, a plasma source, an induction heater, and an e-beam source, into at least one of the powder metal and a portion of the substrate forming the interface between the substrate and powder metal.

12. A method as defined in claim 1, wherein the compacting step further includes providing at least one movable die surface, driving the at least one movable die surface into engagement with the powder metal within the die cavity, and pressing the powder metal within the die cavity.

13. A method as defined in claim 1, wherein the introducing step further includes substantially fluidizing the powder metal to substantially evenly distribute the powder metal throughout the die cavity.

14. A method as defined in claim 13, further comprising fluidizing the powder metal and preheating the fluidized powder metal prior to introduction into the die cavity.

15. A method as defined in claim 14, wherein the preheating includes (i) preheating the powder metal up to about 50% to about 75% of its melting temperature, and (ii) preheating the powder metal up to about 50% to about its melting temperature.

16. A method as defined in claim 1, further comprising providing the substrate in the form of a saw blade, and forming the compacted powder work surface into a net or near net shaped cutting tip of the saw blade.

17. A method as defined in claim 16, further comprising providing the powder metal including a plurality of WC particles coated with at least one of Co and Ni.

18. An apparatus for forming a tool having a compacted powder work surface, comprising:
at least one die surface movable into engagement with a substrate of the tool and forming a die cavity substantially enclosing at least a portion of the substrate;
first means for introducing powder metal into the die cavity;
second means for heating the powder metal to its sintering or melting temperature;
third means for compacting the powder metal within the die cavity and into engagement with the substrate and for forming a near net shape or net shape compacted powder work surface within the die cavity and bonded to the substrate; and
fourth means for disengaging the at least one die surface from the substrate and forming a compacted near net shape or net shape compacted powder work surface on the substrate.

19. An apparatus as defined in claim 18, wherein the first means is a powder metal feed unit; the second means is at least one of a laser source, a RF source, a microwave source, a plasma source, an induction heater, an e-beam source, and a plasma/argon gas source; the third means is at least one of (i) at least one surface forming at least a portion of the die cavity movable into engagement with the powder metal within the die cavity, and (ii) a drive unit for driving at least one of the substrate and die cavity toward the other; and the fourth means is a drive unit for moving at least one die surface and, in turn, disengaging the at least one die surface from the near net shape or net shaped powder metal work surface.

20. An apparatus for forming a tool having a compacted powder work surface, comprising:
at least one die surface movable into engagement with a substrate of the tool and forming a die cavity substantially enclosing at least a portion of the substrate;
a powder metal feed unit in communication with the die cavity for introducing powder metal into the die cavity;
an energy source for at least one of preheating the powder metal prior to introduction into the die cavity, and heating the powder metal in the die cavity;
at least one of (i) at least one surface forming at least a portion of the die cavity movable into engagement with the powder metal within the die cavity for compacting the powder metal within the die cavity into engagement with the substrate, and (ii) a drive unit for driving at least one of the substrate and die cavity toward the other for compacting the powder metal within the die cavity into engagement with the substrate, for forming a near net shape or net shape compacted powder work surface within the die cavity and bonded to the substrate; and
a drive unit that moves at least one die surface to disengage the at least one die surface from the near net shape or net shaped powder metal work surface from the substrate and form a compacted near net shape or net shaped compacted powder work surface on the substrate.

21. An apparatus as defined in claim 20, wherein the energy source is at least one of a laser source, a RF source, a microwave source, a plasma source, an induction heater, an e-beam source, and a plasma/gas source.

22. A tool having a compacted powder metal work surface, the tool being formed in accordance with a method comprising the following steps:
providing a tool substrate;
moving at least one die surface into engagement with the substrate and forming a die cavity substantially enclosing at least a portion of the substrate;
introducing powder metal into the die cavity;
at least one of preheating the powder metal prior to introducing the powder metal into the die cavity, and heating the powder metal in the die cavity;
compacting the powder metal within the die cavity and into engagement with the substrate and forming a near net shape or net shape compacted powder work surface within the die cavity and bonded to the substrate; and
disengaging the at least two die surfaces from the substrate and a compacted near net shape or net shape compacted powder work surface on the substrate.

23. A tool having a compacted powder metal work surface, comprising:
a substrate; and
a compacted powder metal work surface defining a near net or net shape, wherein the powder metal includes a plurality of engineered coated particles including at least one first material coated with at least one second material, wherein the at least one second material portions of the particles are metallurgically bonded to each other and form a dense, compacted powder work surface.

24. A tool as defined in claim 23, further defining an upset at an interface of the substrate and powder metal forming a mechanical interlock between the substrate and powder metal.

25. A tool as defined in claim 24, wherein the upset is defined by at least one of a protuberance and a recess formed on the substrate at an interface between the substrate and powder metal.

26. A tool as defined in claim 24, wherein at least one of the protuberance and recess is substantially dove-tail shaped.

27. A tool as defined in claim 22, wherein the work surface forms at least one of the cutting teeth of a saw blade, the work surface of a jaw of an adjustable wrench, and the head of a screw driver.

28. A tool as defined in claim 22, wherein the first material is tungsten carbide and the second material is at least one of cobalt and nickel.

29. A tool as defined in claim 27, wherein the tool is a saw blade and the work surface defines the tip of at least one cutting tooth of the saw blade.
